(19) United States
(12) Patent Application Publication
(10) Pub. No.: US 2006/0000529 A1
(43) Pub. Date: Jan. 5, 2006

(54) Vehicle window covers

(76) Inventor: Phuc H. Le, Fairfax, VA (US)

Correspondence Address: Jerry C. Lyell, Suite 203, 2009 N. 14th Street, Arlington, VA, 22201, US

(21) Appl. No.: 10/879,497

(22) Filed: Jun. 30, 2004

(51) Int. Cl. B65D 85/00; B65D 65/02; B60J 7/20; B62D 25/06

(52) U.S. Cl. 150/168

(57) ABSTRACT

This invention comprises a set of window covers that are configured to fit onto the doors, and front and rear windows of passenger vehicles. Said door covers are configured to drape onto the tops of (open) vehicle door and then drape downwardly onto to the outside of the doors to a level that covers the windows of each door. Front and rear window covers are fashioned with Velcro® or other fasteners which enable said window covers to be attached to mating fasteners on the door covers. Said covers are preferably made from light weight, woven synthetic fabrics with water and weather resistant properties.

### BACKGROUND OF THE INVENTION

Many styles and configurations of detachable window covers have been patented in the United States. The central idea of all such window covers is that of a protective cover that can be conveniently placed, and secured, onto the exterior surfaces of motor vehicle windows in order to protect the window surfaces from accumulations of ice and snow, or to shield the interior of the vehicle from exposure to the sun's rays.

Typical of such window covers are Bliss's Detachable Window Protector, U.S. Pat. No. 3,140,115, Gebhardt's Windshield Covers, U.S. Pat. No. 4,049,036, Witherspoon's Windshield Cover, U.S. Pat. No. 4,726,406, Lundberg's Windshield Protector, U.S. Pat. No. 5,037,156, Snow's Self-Anchoring Windshield Cover, U.S. Pat. No. 5,211,438, and Madison's Cover for Vehicle Window, U.S. Pat. No. 5,615,923. All of the aforementioned inventions were designed to protect one or more of the windows of passenger-style vehicles, and all of them feature various means of attachment to the vehicle.

The present invention is an improvement over all prior known window covers, particularly in the manner in which the present covers are placed onto and attached to the vehicle, and the fact that the present invention provides complete coverage of all windows in a passenger vehicle. The means of attachment of the various elements of the present invention also increases the quality of weather protection for the vehicle windows beyond that afforded by earlier invention.

### SUMMARY OF THE INVENTION

It is the object of the present invention to provide weather protection for the windows of motor vehicles by means of a novel set of fabric covers that are configured to fit onto the doors and windows of passenger vehicles. Said covers comprise a set and are configured to fit onto the front windshield, back window, and doors (left and right, front and rear) of commercially available passenger vehicles. Said covers are preferably fashioned from light weight woven nylon fabric or other water repellant fabrics with electrometric backing and are configured to slip effortlessly onto the opened doors of passenger vehicles and onto the front and rear windows.

Each door cover is configured to fit onto a particular door: left and right, front and rear. Installation of the door covers is accomplished by opening each door and draping the appropriate cover onto the door, then closing the door. Each cover is configured to fit loosely onto the top and sides of a particular door such that the fabric laps a few inches inside the top and sides of each door and also drapes downwardly onto the outside of each door to a level that covers the windows of each door. The light weight (denier) of the fabric enables the doors to close and latch thereby securing the covers along the tops and sides of the doors. The inside laps of fabric are fashioned with cutouts along the lower inside portions of the covers to accommodate the latches and hinges of the doors.

The windshield cover is fashioned from a single piece of fabric. It is configured to cover the entire area of the windshield of a passenger vehicle and to lap a few inches onto the top of the vehicle and onto the edges of the front door covers. The windshield cover is secured in place by means of mating strips of Velcro® fabric the are affixed to the inside (side) edges of the windshield cover and to the outside front edges of the front door covers. Alternatively, said windshield cover can be attached to the front door covers by means of metal or plastic snaps. Said windshield cover is further fashioned with a continuous strip of magnetized elastomeric material affixed along the underside near the top of said cover. Magnetized elastomeric material is old in the art and is applied in this case to form a dam or seal across the top of the vehicle above the windshield to prevent rain and melting snow from running down onto the windshield. The rear window cover is configured to cover the entire rear window and is fashioned in the same manner as the front cover with mating Velcro® strips and magnetized elastomeric strips attached in the same manner as the front window cover.

The entire set of covers can be installed and removed in approximately one minute. The covers can be folded and stored in a small pouch that is easily carried in the vehicle.

### BRIEF DESCRIPTION OF THE DRAWINGS

FIG. 1 is a three-quarter front view of a vehicle showing a left front door cover in place, a left rear door cover in place and a windshield cover.

FIG. 2 is a left three-quarter front view of a vehicle with windshield cover raised to show the mode of attachment of the windshield cover to the left front door cover.

FIG. 3 shows an opened left front vehicle door with window cover draped onto the door.

FIG. 4 shows an opened left rear vehicle door with window cover draped onto the door.

FIG. 5 is a left three-quarter rear view of a vehicle with rear window cover in place.

### DESCRIPTION OF THE PREFERRED EMBODIMENT

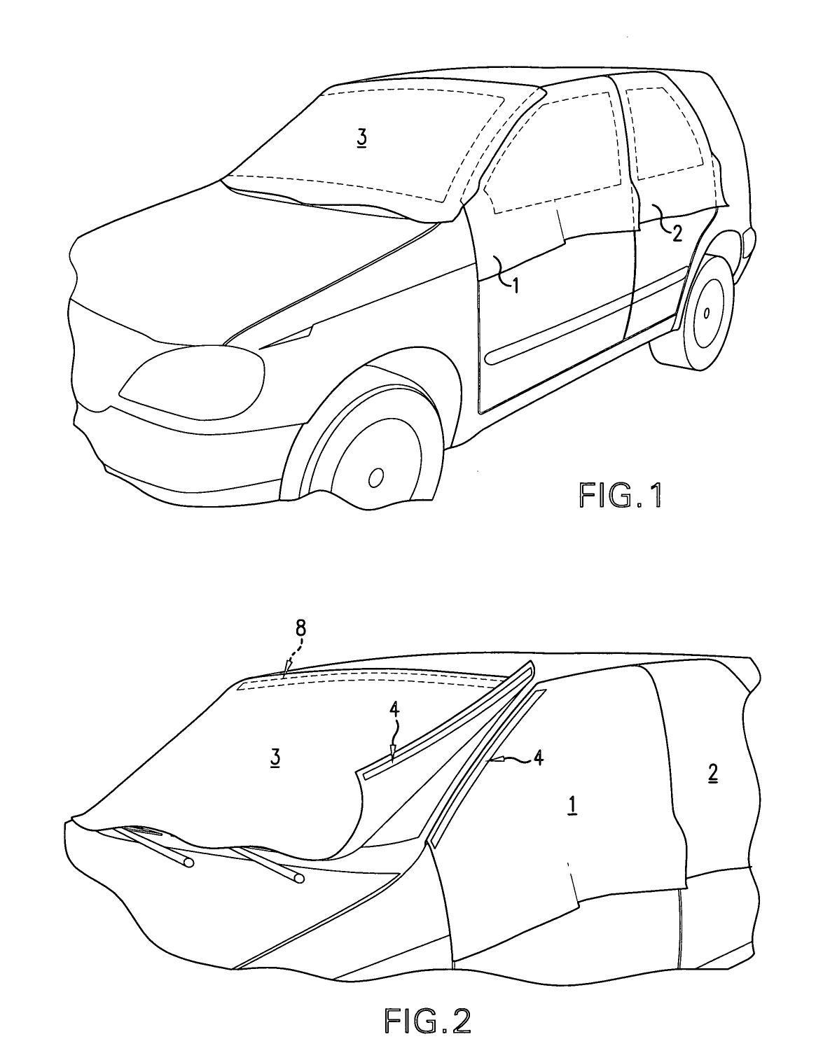

Referring to FIG. 1, one embodiment of the invention can be seen comprising a left front door window cover 1, a left rear vehicle door cover 2 and a windshield cover 3. This view shows the invention properly installed on the left side doors and windshield with doors closed and latched. Covers for the right side vehicle doors are fabricated and installed in exactly the same manner as for the left side. Said covers can be fabricated from a wide selection of materials but light weight (light denier) woven nylon fabric with elastomeric backing is preferred. Such fabrics are old in the art and are impervious to rain and snow thereby preventing the accumulation of snow and frost on the windows of the vehicle.

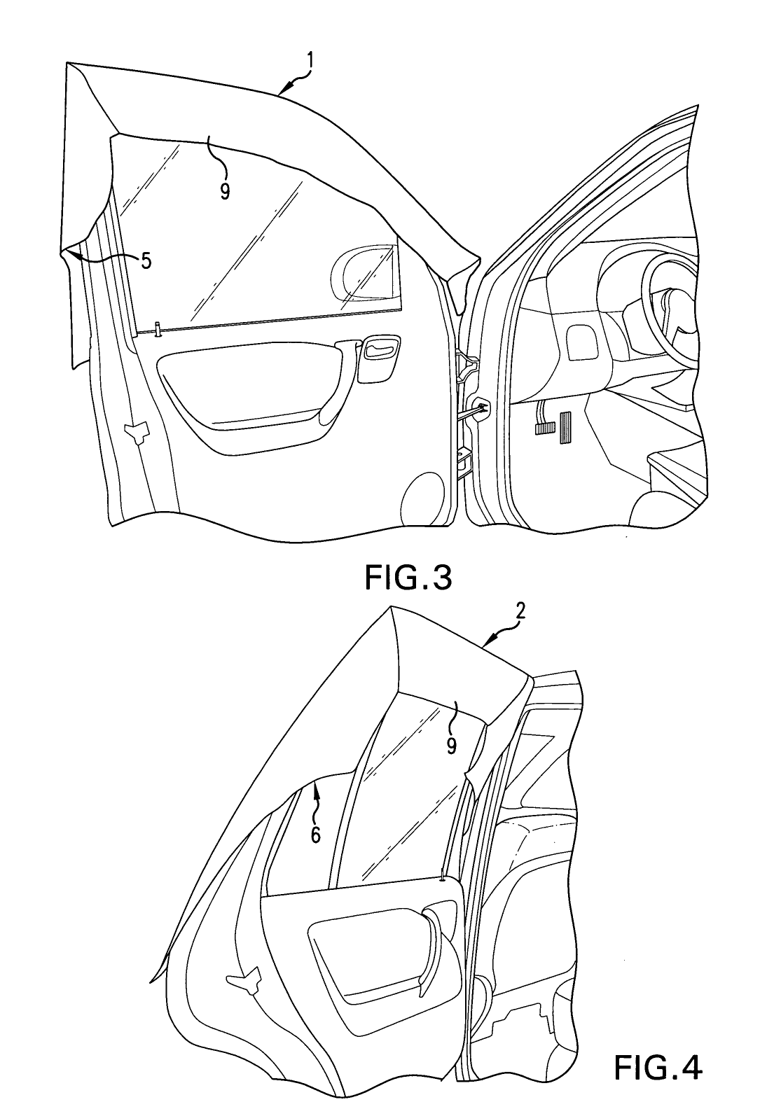

FIG. 2 shows the underside of windshield cover 3 with mating Velcro® strips 4 affixed to the underside of said windshield cover and leading edge of front door cover 1. Reference to Velcro® in this disclosure is by way of illustration and not by way of limitation. Other fastening systems can be employed to connect the window covers to the door covers. FIG. 2 also shows in dashed lines the placement of an magnetized elastomeric strip 8 across the underside near the top of said windshield cover.

FIG. 3 shows the manner in which the fabric of the front door cover 1 is lapped onto the top and sides of said door. Said lap 9 can be tacked at the corners with thread or glue, or the laps can simply be unsecured at the corners. Said front door cover is further fashioned with a cutout 5 which enables the engagement of door latches and hinges without interference from the fabric of the cover.

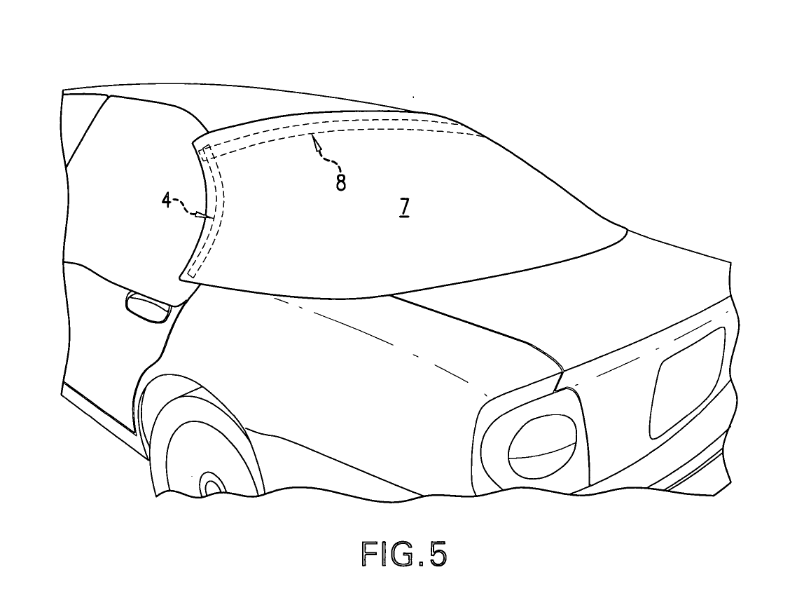

FIG. 4 shows the manner of installing a cover on a rear vehicle door. Said rear door cover is also fashioned with a cutout 6 to enable the engagement of the rear door latches and hinges.

FIG. 5 shows a rear window cover 7 in place. In this view can also be seen, represented by dashed lines, a Velcro® strip 4 and magnetized elastomeric strip 8.

Most passenger vehicles are size-classed as compact, medium or full size. Accordingly, the present invention can be primarily manufactured in just three sizes to fit onto the vast majority of passenger vehicles including sport utility vehicles. Larger sized window and windshield covers can be manufactured for trucks and other vehicles.

I claim:

1. A set of protective covers for the windows of motor vehicles comprising:
a fabric cover configured to fit onto the exterior of a front door of a passenger vehicle,
a fabric cover configured to fit onto the exterior of a rear door of a passenger vehicle,
a fabric cover configured to fit onto the front windshield of a passenger vehicle, and
a fabric cover configured to fit onto the rear window of a passenger vehicle.

2. The invention of claim 1 wherein said front and rear door covers comprise left-handed and right-handed pairs of covers.

3. The invention of claim 1 wherein said door covers are fashioned with laps of fabric which turn downward and inward along the tops and sides of said doors.

4. The invention of claim 1 wherein said front window cover laps onto the top surface of a vehicle above a front window.

5. The invention of claim 1 wherein said rear window cover laps onto the top surface of a vehicle above a rear window.

6. The invention of claim 1 wherein the sides of said front and rear window covers are attached to the side door covers by means of mating or matching fastener systems attached to the covers.

7. The invention of claim 1 wherein said front and rear window covers are fashioned with magnetized elastomeric strips attached to the undersides near the tops of said covers.

8. The invention of claim 1 wherein said covers are made weather and water resistant by means of an elastomeric film affixed to the underside of said covers.

9. The invention of claim 1 wherein said set of protective covers are configured to fit onto sport utility vehicles (SUV's).
